(19) United States
(12) Patent Application Publication
(10) Pub. No.: US 2011/0309983 A1
(43) Pub. Date: Dec. 22, 2011

(54) THREE-DIMENSIONAL DIRECTION FINDING FOR ESTIMATING A GEOLOCATION OF AN EMITTER

(76) Inventors: Tyler Holzer, Sacramento, CA (US); Bart Peters, Aurora, CO (US); David T. Driggs, Golden, CO (US); Greg Manassero, San Jose, CA (US)

(21) Appl. No.: 13/165,473

(22) Filed: Jun. 21, 2011

Related U.S. Application Data
(60) Provisional application No. 61/356,891, filed on Jun. 21, 2010.

(51) Int. Cl. G01S 5/02

(52) U.S. Cl. 342/451

(57) ABSTRACT

One embodiment of the invention includes a computer readable medium configured to perform a method for determining a three-dimensional geolocation of a terrestrial emitter. The method includes receiving a signal from the emitter at an antenna array. The method also includes determining a three-dimensional line-of-position (LOP) to the emitter based on the signal. The three-dimensional LOP can include an azimuth angle and a depression angle. The method further includes calculating the three-dimensional geolocation of the emitter based on an intersection of the three-dimensional LOP with digital terrain elevation data (DTED) associated with the Earth's surface.

### CROSS REFERENCE TO RELATED APPLICATION

The present application claims filing benefit of U.S. Provisional Application No. 61/356,891 having a filing date of Jun. 21, 2010, which is incorporated herein by reference in its entirety.

### TECHNICAL FIELD

The present invention relates generally to communications systems, and specifically to three-dimensional direction finding for estimating a geolocation of an emitter.

### BACKGROUND

Direction finding (DF) can refer to an estimation of a direction of arrival (DOA) for a given signal that is intercepted. The purpose of DF systems is to locate the source (i.e., emitter) of a radiated signal-of-interest. To locate the position of an unknown source of transmission, signals can be collected by specialized DF equipment. There can be various types of platforms for DF equipment, including ground-based and air-borne collection platforms. In simple DF systems, once a signal is collected it is processed to form a DOA, which can represent a line-of-position (LOP) on the earth comprising the set of geographic points from which the unknown transmission is feasible. DF can be implemented for DF geolocation in which a transmission source is precisely located at a fixed point intersection (i.e., a “fix”) of two or more LOPs. The success of DF geolocation estimates can often be based on spatial and/or angular separation between the DF platforms used to collect the signal. As an example, spatial and/or angular separation can be achieved by incorporating inputs from more than one DF collection platform or by utilizing a single DF platform to collect signals at multiple locations. However, implementing inputs from more than one location to generate a geolocation estimate can be costly, and implementing a single platform to collect signals at multiple locations can be time consuming.

### SUMMARY

One embodiment of the invention includes a computer readable medium configured to perform a method for determining a three-dimensional geolocation of a terrestrial emitter. The method includes receiving a signal from the emitter at an antenna array. The method also includes determining a three-dimensional line-of-position (LOP) to the emitter based on the signal. The three-dimensional LOP can include an azimuth angle and a depression angle. The method further includes calculating the three-dimensional geolocation of the emitter based on an intersection of the three-dimensional LOP with digital terrain elevation data (DTED) associated with the Earth's surface.

Another embodiment of the invention includes a geolocation system. The system includes an airborne antenna array configured to receive at least one signal from an emitter. The system also includes a LOP calculation component configured to calculate a three-dimensional LOP to the emitter that includes an azimuth angle and a depression angle based on phase information associated with the at least one signal. The system also includes a geolocation calculation component configured to calculate the three-dimensional geolocation of the emitter based on an intersection of the three-dimensional LOP with DTED associated with the Earth's surface. The geolocation calculation component is also configured to generate an error region associated with a probable geolocation of the emitter on the DTED associated with the Earth's surface based on the three-dimensional LOP.

Another embodiment of the invention includes a computer readable medium configured to perform a method for determining a three-dimensional geolocation of an emitter. The method includes receiving at least one signal from the emitter at an antenna array. The method also includes determining at least one three-dimensional LOP to the emitter based on phase information associated with the respective at least one signal. Each of the at least one LOP can include an azimuth angle and a depression angle. The method also includes generating an error region associated with a probable geolocation of the emitter based on an intersection of the at least one three-dimensional LOP with digital terrain elevation data (DTED) associated with the Earth's surface.

### BRIEF DESCRIPTION OF THE DRAWINGS

FIG. 1 illustrates an example of a geolocation system in accordance with an aspect of the invention.

FIG. 2 illustrates an example diagram of an azimuth angle to an emitter in accordance with an aspect of the invention.

FIG. 3 illustrates an example diagram of a depression angle to an emitter in accordance with an aspect of the invention.

FIG. 4 illustrates an example diagram of determining a fix on digital terrain elevation data in accordance with an aspect of the invention.

FIG. 5 illustrates another example of a geolocation calculation component in accordance with an aspect of the invention.

FIG. 6 illustrates an example diagram of generating an error region in accordance with an aspect of the invention.

FIG. 7 illustrates another example diagram of generating an error region in accordance with an aspect of the invention.

FIG. 8 illustrates yet another example diagram of generating an error region in accordance with an aspect of the invention.

FIG. 9 illustrates a computer system in accordance with an aspect of the invention.

FIG. 10 illustrates an example of a method for determining a three-dimensional geolocation of a terrestrial emitter in accordance with an aspect of the invention.

### DETAILED DESCRIPTION

The present invention relates generally to communications systems, and specifically to three-dimensional direction finding for estimating a geolocation of an emitter. A three-dimensional direction finding system can include an array of antennas, such as included on an airborne vehicle, that is configured to receive one or more signals from an emitter, such as a terrestrial emitter. The system can also include a three-dimensional line-of-position (LOP) calculation component, which can be implemented as computer readable media, such as including hardware, firmware, software, or a combination thereof. The three-dimensional LOP calculation component can be configured to determine a three-dimensional LOP to the emitter from the antenna array based on phase information of the received at least one signal. As an example, the three-dimensional LOP can include both an azimuth angle and a depression angle. As described herein, the determined azimuth angle and the depression angle for the three-dimensional LOP can define an observation for the determination of the three-dimensional LOP. The system also includes a geolocation calculation component that can similarly be implemented as hardware, firmware, software, or a combination thereof. The geolocation calculation component can estimate a geolocation of the emitter based on an intersection of the three-dimensional LOP with the Earth's surface. For example, the geolocation calculation component can estimate the geolocation of the emitter based on an intersection of the three-dimensional LOP with digital terrain elevation data (DTED) associated with the Earth's surface.

The geolocation calculation component can also be configured to generate an error region associated with a probable location of the emitter. For example, the error region can be associated with a percentage of likelihood (e.g., 50%) that the emitter is located in a geographical region encompassed by the error region. As an example, the geolocation component can be configured to define angles of uncertainty with respect to both the azimuth angle and the depression angle to generate an error ellipse that defines the error region based on intersection of the error ellipse with the Earth's surface (e.g., with the DTED). As another example, the three-dimensional LOP calculation component can be configured to determine a plurality of three-dimensional lines-of-position (LOPs), such as from multiple positions of a single aircraft or from multiple aircraft. Thus, the geolocation calculation component can be configured to generate a three-dimensional error ellipsoid based on the plurality of three-dimensional LOPs, with the error region being defined based on an intersection of the error ellipsoid with the Earth's surface (e.g., the DTED).

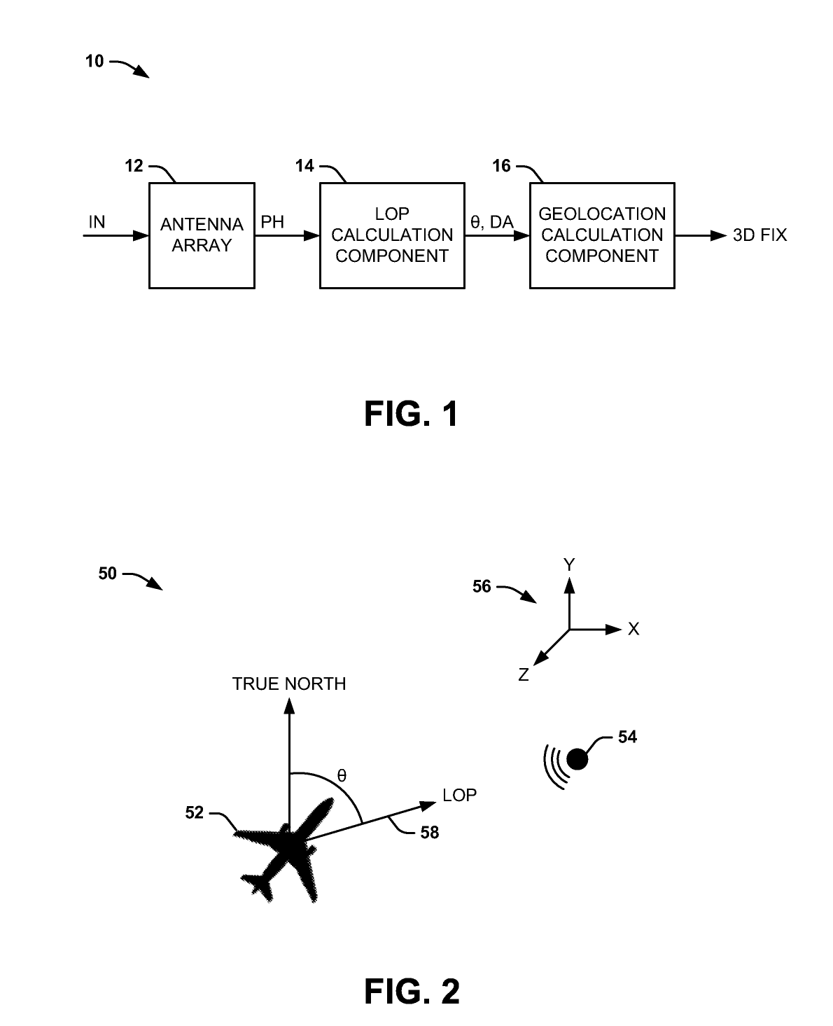

FIG. 1 illustrates an example of a geolocation system 10 in accordance with an aspect of the invention. The geolocation system 10 is configured to determine an estimate of a geolocation of an emitter based on received signals that are provided from the emitter. As an example, the emitter can be a terrestrial emitter. The geolocation system 10 can be located in part or in whole on an aircraft. Additionally, portions of the geolocation system 10 can be implemented as software, firmware, or in combination with hardware.

The geolocation system 10 includes an antenna array 12. As an example, the antenna array 12 can be a three-dimensional antenna array that is configured to receive at least one signal IN that is provided from the emitter. The geolocation system 10 also includes a LOP calculation component 14 that is configured to monitor phase information associated with the signal(s) IN with respect to the antenna array 12, demonstrated in the example of FIG. 1 as PH. As an example, based on a three-dimensional configuration of the antenna array 12, a difference in phase of the signal(s) IN with respect to each of a plurality of antennas in the antenna array 12 can be monitored by the LOP calculation component 14. Thus, the difference in phase of the signal(s) IN as received by the antenna array 12 can be indicative of a direction from which the signal(s) IN are received in three-dimensional space. As a result, the LOP calculation component 14 can be configured to determine a three-dimensional LOP from the antenna array 12 to the emitter based on the phase information PH.

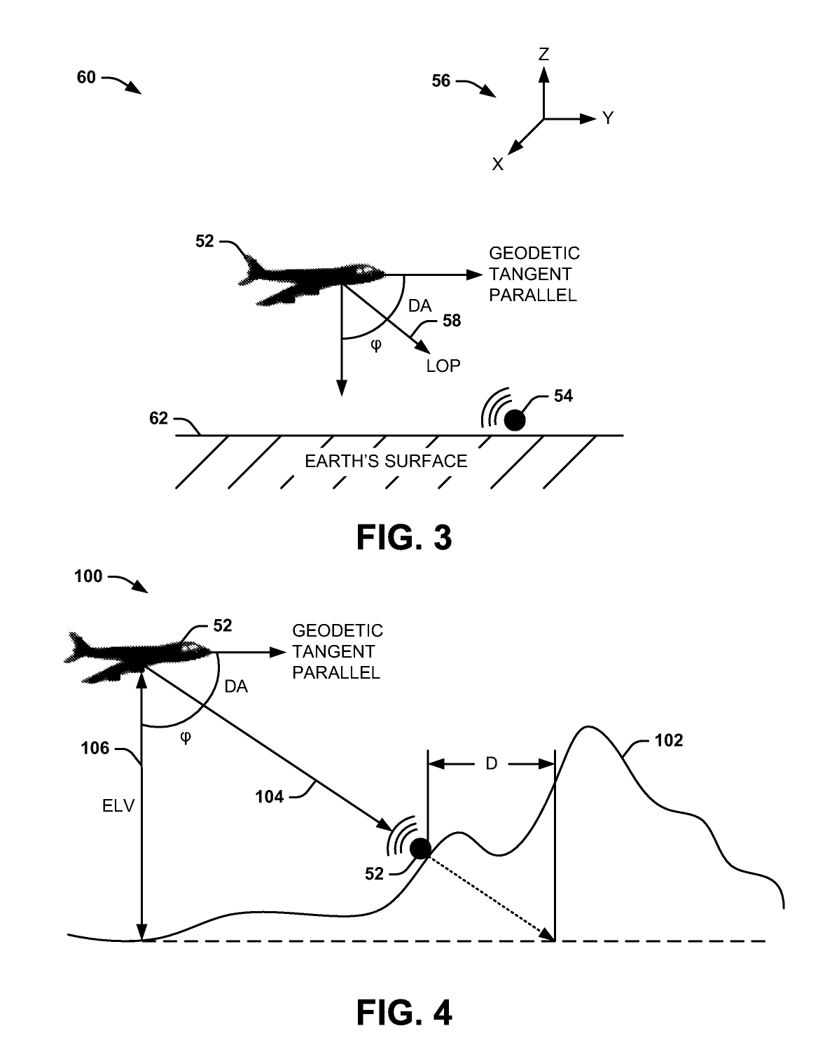

Because the LOP that is determined by the LOP calculation component 14 is with respect to three-dimensional space, the LOP calculation component 14 can determine both an azimuth angle θ and a depression angle DA associated with the three-dimensional LOP. The azimuth angle θ and depression angle DA are better explained with respect to the examples of FIGS. 2 and 3. FIG. 2 illustrates an example diagram 50 of an azimuth angle to an emitter in accordance with an aspect of the invention. FIG. 3 illustrates an example diagram 60 of a depression angle to an emitter in accordance with an aspect of the invention. The diagrams 50 and 60 each demonstrate an aircraft 52 positioned relative to an emitter 54 in three-dimensional space, as indicated by a Cartesian coordinate system 56.

The diagram 50 in the example of FIG. 2 demonstrates an overhead view of the aircraft 52 and the emitter 54, and thus demonstrating the aircraft 52 and the emitter 54 in the XY-plane relative to each other. The diagram 50 demonstrates a LOP 58 from the aircraft 52 to the emitter 54, such as determined by the LOP calculation component 14 in the example of FIG. 1. The LOP 58 is thus demonstrated as having an azimuth angle θ relative to True North (i.e., a vector pointing to the North Pole of the Earth). Similarly, the diagram 60 in the example of FIG. 3 demonstrates a side view of the aircraft 52 and the emitter 54, and thus demonstrating the aircraft 52 and the emitter 54 in the YZ-plane relative to each other. The diagram 50 demonstrates the LOP 58 from the aircraft 52 to the emitter 54 as having a depression angle DA relative to a plane that is parallel to a geodetic tangent plane with respect to the Earth's surface 62 (i.e., normal to a vector 64 associated with true Nadir), demonstrated in the example of FIG. 3 as GEODETIC TANGENT PARALLEL. The LOP 58 is also demonstrated as having a cone angle φ with respect to the vector 64.

Referring back to the example of FIG. 1, the LOP calculation component 14 provides the azimuth angle θ and depression angle DA of the three-dimensional LOP 58 to a geolocation calculation component 16. The geolocation calculation component 16 can provide an estimate of a three-dimensional location of the emitter 54 (i.e., a three-dimensional fix) based on an intersection of the three-dimensional LOP with the Earth's surface 62. Thus, the geolocation of the emitter can be estimated in terms of latitudinal and longitudinal coordinates relative to an instantaneous position of the aircraft 52 (i.e., the antenna array 12 from which the three-dimensional LOP 58 emanates). As an example, the information associated with the Earth's surface 62 can be ascertained by the geolocation system 10 based on elevation data of the aircraft 52, such as can be determined from a nav unit of the aircraft 52. As another example, the geolocation calculation component 16 can implement DTED associated with the Earth's surface 62. For example, the geolocation calculation component 16 can estimate the geolocation of the emitter 54 based on an intersection of the three-dimensional LOP 58 with the DTED for a more accurate estimate of the fix of the emitter 54 in three-dimensional space.

FIG. 4 illustrates an example diagram 100 of determining a fix on DTED in accordance with an aspect of the invention. The diagram 100 demonstrates the aircraft 52 flying over mountainous terrain 102, in accordance with the same Cartesian coordinate system 56 in the examples of FIGS. 2 and 3. Thus, the diagram 100 illustrates a two-dimensional view of the aircraft 52 over the mountainous terrain 102 in the YZ-plane. The diagram 100 also includes the emitter 54 located on the mountainous terrain 102.

The diagram 100 demonstrates a three-dimensional LOP 104 emanating from the aircraft having a depression angle DA relative to the plane that is normal to a true Nadir vector 106. It is to be understood that the three-dimensional LOP 104 can also have an associated azimuth angle θ relative to True North in the XY-plane. As an example, the three-dimensional LOP 104 can be determined by the LOP calculation component 14 based on the phase information PH of one or more signals having been provided from the emitter 54 and received at the antenna array 12. The LOP calculation component 14 can provide the azimuth angle θ and depression angle DA of the three-dimensional LOP 104 to the geolocation calculation component 16 for determination of the fix corresponding to the estimate of the location of the emitter on the surface of the Earth.

As described above, the geolocation calculation component 16 can determine the fix based on an intersection of the three-dimensional LOP 104 with the Earth's surface. However, as demonstrated by the mountainous terrain 102 in the example of FIG. 4, the Earth's surface is variable. At the instantaneous position of the aircraft 52, the aircraft 52 has an elevation that is demonstrated as ELV directly above the mountainous terrain 102 of the surface of the Earth. Thus, if the geolocation calculation component 16 relies on the elevation data, such as provided from the nay unit of the aircraft 52, the geolocation calculation component 16 would estimate the geolocation of the emitter 54 to be at a first location 108. The first location 108 corresponds to the location at which the three-dimensional LOP 104 intersects a geodetic plane spaced apart from the aircraft 52, and thus the origin of the three-dimensional LOP 104, by the elevation ELV. Thus, the first location 108 is an incorrect estimate of the emitter 54, and is geometrically offset from the true location of the emitter 54 by a distance of “D” in two-dimensional space (i.e., in the XY-plane).

Alternatively, as also described above, the geolocation calculation component 16 can determine the estimate of the geolocation of the emitter 54 based on the DTED. For example, the DTED can represent the variations in elevation of the surface of the Earth, such that the variations in the mountainous terrain 102 can be digitally represented by the DTED. As a result, the geolocation calculation component 16 can much more accurately estimate the geolocation of the emitter 54 based on an intersection of the three-dimensional LOP 104 with the DTED, as opposed to relying on other data corresponding to the Earth's surface, such as elevation data associated with the aircraft 52. In the example of FIG. 4, by implementing the DTED, the geolocation calculation component 16 can more accurately estimate the fix of the emitter 54 as having a geolocation on the mountainous terrain 102, as opposed to being offset by the distance D.

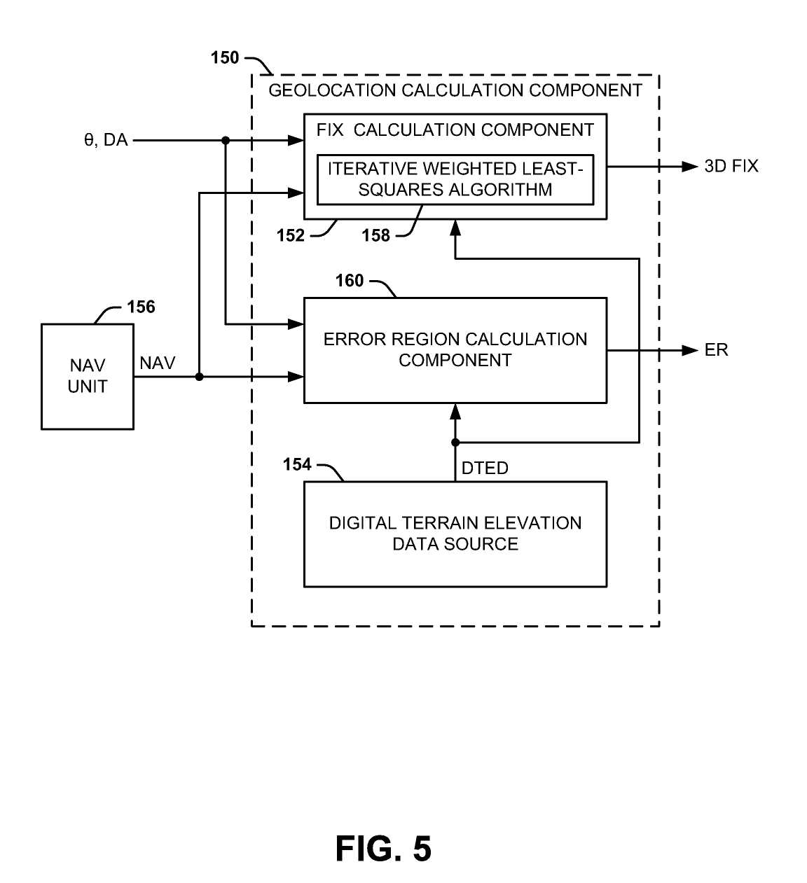

FIG. 5 illustrates another example of a geolocation calculation component 150 in accordance with an aspect of the invention. The geolocation calculation component 150 can correspond to the geolocation calculation component 16 in the example of FIG. 1. Therefore, reference is to be made to the examples of FIGS. 1-4 in the following description of the example of FIG. 5.

The geolocation calculation component 150 includes a fix calculation component 152. The fix calculation component 152 receives the azimuth angle θ and depression angle DA of a three-dimensional LOP (e.g., the three dimensional LOPs 58 and/or 104) and generates an estimate of the geolocation of the emitter 54 based on an intersection of the three-dimensional LOP with the DTED. In the example of FIG. 5, the DTED is demonstrated as being provided from digital terrain elevation data source 154, which can correspond to a memory that stores the DTED or a data receiver that receives the DTED for processing by the fix calculation component 152. As another example, the digital terrain elevation data source 154 could be configured external to the geolocation calculation component 150. The fix component 152 can also implement navigation information NAV that is provided from a nay unit 156 to generate the estimate of the geolocation of the emitter 54 in a geographical reference, such as with respect to latitude, longitude, and/or elevation. As an example, the nav unit 156 could be configured as the navigation unit of the associated aircraft from which the three-dimensional LOP emanates.

To estimate the geolocation of the emitter 54, the fix calculation component 152 first defines the three-dimensional LOP as a vector v. The vector v thus connects two points: the estimate for the location of the emitter 54 and a known location of the collector (i.e., the antenna array 12) at the time of receiving the signal IN. Therefore, the vector v can be expressed as follows:

v=(iₑ−i_{c},jₑ−jₑ,kₑ−k_{c}) Equation 1

In Equation 1, the terms “i”, “j”, and “k” correspond to a location in an IJK coordinate system. The IJK coordinate system is a Collector-Centered Cartesian coordinate frame in which the T-axis lies along a boresight-to-collector slant vector, the k-axis is perpendicular to the i-axis and lies in the plane containing the slant vector and a vector through the boresight parallel to a z-axis of an the Earth-Centered the Earth-Fixed (ECEF) Cartesian coordinate frame. Thus, the j-axis is the remaining vector perpendicular to both i and k. In Equation 1, the subscripts “e” and “c” denote “emitter” and “collector”, respectively.

Because the UK coordinate system is a collector-centered coordinate system, the collector coincides with the origin. As a result, the collector terms are canceled from Equation 1, resulting in the following expression:

v=(iₑ,jₑ,kₑ) Equation 2

With knowledge of the vector v and its components (i,j,k), the azimuth angle θ and the depression angle DA can be trigonometrically determined as follows:

$$\begin{matrix}tan θ = ( \frac{j}{k} ) & Equation 3 \\ θ = {tan}^{- 1} ( \frac{j}{k} ) & Equation 4 \\ DA = {cos}^{- 1} ( \frac{i \cdot v}{\vert \vec{i} \vert \vert \vec{v} \vert} ) & Equation 5\end{matrix}$$

Since \vec{i}=(−1, 0, 0), |\vec{i}|=1, and |\vec{ν}|=\sqrt{i²+j²+k²}, the cone angle φ can be expressed as:

$$φ = {cos}^{- 1} ( \frac{- i}{\sqrt{{i}^{2} + {j}^{2} + {k}^{2}}} ) \qquad Equation 6$$

Therefore, the depression angle DA can then be calculated as follows:

$$DA = \frac{π}{2} - {cos}^{- 1} ( \frac{- i}{\sqrt{{i}^{2} + {j}^{2} + {k}^{2}}} ) \qquad Equation 7$$

From Equations 2-7, partial derivatives of the azimuth angle θ and the cone angle φ can be determined with respect to the IJK coordinate system. For the azimuth angle θ, the partial derivatives can be expressed as follows:

$$\frac{\partial θ}{\partial i} = 0 \\ \frac{\partial θ}{\partial j} = \frac{k}{{j}^{2} + {k}^{2}} \\ \frac{\partial θ}{\partial k} = \frac{- j}{{j}^{2} + {k}^{2}} \qquad Equation 8$$

The partial derivative of the i term is zero based on there being no upward component of the azimuth angle θ. For the cone angle φ, the partial derivatives can be expressed as follows:

$$\frac{\partial φ}{\partial i} = \frac{\sqrt{{j}^{2} + {k}^{2}}}{{i}^{2} + {j}^{2} + {k}^{2}} \\ \frac{\partial φ}{\partial j} = \frac{- ij}{\sqrt{{j}^{2} + {k}^{2}} ( {i}^{2} + {j}^{2} + {k}^{2} )} \\ \frac{\partial φ}{\partial k} = \frac{- ik}{\sqrt{{j}^{2} + {k}^{2}} ( {i}^{2} + {j}^{2} + {k}^{2} )} \qquad Equations 9$$

Therefore, because the derivative of π/2 equals 0, the partial derivatives of the depression angle DA can be expressed as follows:

$$\frac{\partial DA}{\partial i} = - \frac{\sqrt{{j}^{2} + {k}^{2}}}{{i}^{2} + {j}^{2} + {k}^{2}} \\ \frac{\partial DA}{\partial j} = \frac{ij}{\sqrt{{j}^{2} + {k}^{2}} ( {i}^{2} + {j}^{2} + {k}^{2} )} \\ \frac{\partial DA}{\partial k} = \frac{ik}{\sqrt{{j}^{2} + {k}^{2}} ( {i}^{2} + {j}^{2} + {k}^{2} )} \qquad Equations 10$$

The boresight of the formulations in Equations 8-10 can be selected to be the Nadir point of the antenna array 12. Because the k-vector of the IJK coordinate system points North, the IJK coordinate system can be converted to an East-North-Up (ENU) coordinate frame for the calculation of the predicted observations and the partial derivatives of Equations 8-10. The ENU coordinate system is an Emitter-Centered Cartesian coordinate frame in which the East-North (EN) plane is the tangent plane to the Earth at the location of the emitter 54, the East and North axes lie in those respective directions within the tangent plane, and the Up axis extends vertically up perpendicular to the surface of the Earth. The Up axis can be perpendicular to either a geocentric or a geodetic surface of the Earth. Based on conversion of the IJK coordinate system to the ENU coordinate system with the IJK boresight selected as the Nadir point of the antenna array 12, the I-axis becomes the N-axis, the K-axis becomes the N-axis, and the J-axis becomes East. The vector v=(i, j, k) can thus be posed as (e, n, u), because even though the two coordinate systems have different zero-point origins, the fact that they are parallel means that vectors remain the same between both coordinate systems.

The expressions in the above Equations can thus be rewritten in the ENU coordinate system. Specifically, for the azimuth angle θ, Equations 4 and 8 can be expressed in the ENU coordinate system as follows:

$$θ = {tan}^{- 1} ( \frac{e}{n} ) \\ \frac{\partial θ}{\partial e} = \frac{n}{{e}^{2} + {n}^{2}} \\ \frac{\partial θ}{\partial n} = \frac{- e}{{e}^{2} + {n}^{2}} \\ \frac{\partial θ}{\partial u} = 0 \qquad Equations 11$$

Equations 6 and 9 can be expressed in the ENU coordinate system as follows:

$$φ = {cos}^{- 1} ( \frac{- u}{\sqrt{{e}^{2} + {n}^{2} + {u}^{2}}} ) \\ \frac{\partial φ}{\partial e} = \frac{- ue}{\sqrt{{e}^{2} + {n}^{2}} ( {e}^{2} + {n}^{2} + {u}^{2} )} \\ \frac{\partial φ}{\partial n} = \frac{- un}{\sqrt{{e}^{2} + {n}^{2}} ( {e}^{2} + {n}^{2} + {u}^{2} )} \\ \frac{\partial φ}{\partial u} = \frac{\sqrt{{e}^{2} + {n}^{2}}}{{e}^{2} + {n}^{2} + {u}^{2}} \qquad Equations 12$$

Equations 7 and 10 can be expressed in the ENU coordinate system as follows:

$$DA = \frac{π}{2} - {cos}^{- 1} ( \frac{- u}{\sqrt{{e}^{2} + {n}^{2} + {u}^{2}}} ) \\ \frac{\partial DA}{\partial e} = \frac{ue}{\sqrt{{e}^{2} + {n}^{2}} ( {e}^{2} + {n}^{2} + {u}^{2} )} \\ \frac{\partial DA}{\partial n} = \frac{un}{\sqrt{{e}^{2} + {n}^{2}} ( {e}^{2} + {n}^{2} + {u}^{2} )} \\ \frac{\partial DA}{\partial u} = - \frac{\sqrt{{e}^{2} + {n}^{2}}}{{e}^{2} + {n}^{2} + {u}^{2}} \qquad Equations 13$$

Having formulated the partial derivatives in the ENU coordinate system above, the fix calculation component 152 can then express the vectors in the ENU coordinate system in an equivalent form in the ECEF Cartesian coordinate frame. In the ECEF coordinate frame, the positive x-axis extends from the center of the Earth out through 0° latitude/0° longitude, the positive y-axis extends from the center of the Earth out through 0° latitude/90° East longitude, and the positive z-axis extends from the center of the Earth out through 90° latitude (i.e., the North Pole). Thus, for a point on the Earth (or in free space) given by (x, y, z), the local upward pointing vector \vec{U} can be expressed by:

$$\vec{U} = \frac{( x , y , α z )}{\sqrt{{x}^{2} + {y}^{2} + {( α z )}^{2}}} \qquad Equation 14$$

For a geocentric (i.e., spherical Earth) upward pointing vector \vec{U}, α=1. For a geodetic (i.e., oblate Earth) upward pointing vector \vec{U}, α can be expressed as follows:

$$α = {( \frac{ER + alt}{PR + alt} )}^{2} \qquad Equation 15$$

Where:
ER=the Equatorial Radius of the Earth,
PR=the Polar Radius of the Earth, and
alt=local altitude at the point of interest.
   The East-pointing vector \vec{E} can be formed from the cross product of the upward pointing vector \vec{U} and the z-axis, as follows:

$$\vec{E} = \frac{( 0 , 0 , 1 ) \times \vec{U}}{\vert ( 0 , 0 , 1 ) \times \vec{U} \vert} \qquad Equation 16$$

The North-pointing vector \vec{N} can be formed from the cross product of the upward pointing vector \vec{U} and the East-pointing vector \vec{E}, as follows:

\vec{N}=\vec{U} ×\vec{E} Equation 17

Based on the conversion of the right-handed ENU coordinate system definitions in terms of the ECEF XYZ coordinate system, the fix calculation component 152 can construct matrices by which to rotate vectors in the XYZ coordinate system to the ENU coordinate system and vice versa. Using \vec{E}, \vec{N}, and \vec{U} as defined above, for a vector \vec{V}, the following expressions can be defined:

$${\vec{V}}_{ENU} = [ \begin{matrix}{\vec{E}}^{T} \\ {\vec{N}}^{T} \\ {\vec{U}}^{T}\end{matrix} ] {\vec{V}}_{XYZ} \\ {\vec{V}}_{XYZ} = [ \begin{matrix}\vec{E} & \vec{N} & \vec{U}\end{matrix} ] {\vec{V}}_{ENU} \qquad Equation 18$$

The Equations 18 can be ascertained based on the following relationship:

$${[ \begin{matrix}{\vec{E}}^{T} \\ {\vec{N}}^{T} \\ {\vec{U}}^{T}\end{matrix} ]}^{T} = [ \begin{matrix}{\vec{E}}^{T} & {\vec{N}}^{T} & {\vec{U}}^{T}\end{matrix} ] = {[ \begin{matrix}{\vec{E}}^{T} \\ {\vec{N}}^{T} \\ {\vec{U}}^{T}\end{matrix} ]}^{- 1} \qquad Equation 19$$

In the example of FIG. 5, the fix calculation component 152 includes an iterative weighted least-squares algorithm (IWLSA) 158 that is implemented by the fix calculation component 152 for estimating the geolocation of the emitter 54 based on the preceding definitions set forth in the Equations above. In the IWLSA 158, x is defined to be the true location of the emitter 54 in the Cartesian ECEF XYZ-space, and \hat{x} is defined as the estimate of x. The IWLSA 158 can thus define values for 2 as follows:

\hat{x}ᵢ=\hat{x}ᵢ₋₁−(A^{T}WA)⁻¹A^{T}We Equation 20

Where:
xᵢ is an estimate for x on the i^{th} iteration of the algorithm for the geolocation of the emitter 54 in ECEF XYZ coordinates;
A is a matrix of partial derivatives of the observations with respect to the solution space of x;
W is a weighting matrix; and
e is a vector of residual errors.
   In implementing the IWLSA 158, Equation 20 should converge on an answer which minimizes a weighted sum of squared error term, e^{T}We, and thus represents a substantially accurate result based on the one or more observations collected by the antenna array 12.

The A and W matrices and the e vector can be filled by the IWLSA 158 with azimuth angles θ, with cone angles φ, with depression angles DA, with any number of complete pairs of three-dimensional direction-finding measurements, and/or with any combination of complete and incomplete pairs of measurements based on whatever model and corresponding derivatives are appropriate for the collection of observations. In general, the matrix A can take the following form:

$${A}_{enu} = [ \begin{matrix}\frac{\partial {AOA}_{1}}{\partial e} & \frac{\partial {AOA}_{1}}{\partial n} & \frac{\partial {AOA}_{1}}{\partial u} \\ \frac{\partial {AOA}_{2}}{\partial e} & \frac{\partial {AOA}_{2}}{\partial n} & \frac{\partial {AOA}_{2}}{\partial u} \\ ⋮ & ⋮ & ⋮ \\ \frac{\partial {AOA}_{n}}{\partial e} & \frac{\partial {AOA}_{n}}{\partial n} & \frac{\partial {AOA}_{n}}{\partial u}\end{matrix} ] \qquad Equation 21$$

Where AOAᵢ corresponds to one of an azimuth angle θ, a cone angle φ, or a Depression Angle DA.
   The matrix of Equation 21 can be expressed in the ENU coordinate system as follows:

$$A = {A}_{xyz} = [ \begin{matrix}\frac{\partial {AOA}_{1}}{\partial x} & \frac{\partial {AOA}_{1}}{\partial y} & \frac{\partial {AOA}_{1}}{\partial z} \\ \frac{\partial {AOA}_{2}}{\partial x} & \frac{\partial {AOA}_{2}}{\partial y} & \frac{\partial {AOA}_{2}}{\partial z} \\ ⋮ & ⋮ & ⋮ \\ \frac{\partial {AOA}_{n}}{\partial x} & \frac{\partial {AOA}_{n}}{\partial y} & \frac{\partial {AOA}_{n}}{\partial z}\end{matrix} ] \qquad Equation 22$$

Based on the relationship that

$${A}_{xyz} = {A}_{enu} [ \begin{matrix}{{E}^{->}}^{T} \\ {\vec{N}}^{T} \\ {\vec{U}}^{T}\end{matrix} ] ,$$

where

$$[ \begin{matrix}{\vec{E}}^{T} \\ {\vec{N}}^{T} \\ {\vec{U}}^{T}\end{matrix} ]$$

is equivalent to [\vec{E} \vec{N} \vec{U} ]^{T} and is one of the 3×3 matrices from the section on Coordinate Conversions which can rotate vectors in the ENU coordinate system to the XYZ coordinate system.

The matrix W can be defined by the IWLSA 158 in a variety of ways. Depending on how the matrix W is constructed, the estimate \hat{x} can take on various properties, such as minimum variance, unbiased, and a variety of others. The matrix W can have a direct effect on a resulting error region, as described in greater detail below, that can surround the estimate for x. As an example, where the azimuth angles θ, the cone angles φ, and the depression angles DA are uncorrelated, the matrix W can be selected to be the inverse of the covariance on the observations, such that the matrix W can take the following form:

$$\begin{matrix}W = {COV}^{- 1} \\ = {[ \begin{matrix}{σ}_{{AOA}_{1}}^{2} & 0 & 0 & 0 \\ 0 & {σ}_{{AOA}_{2}}^{2} & 0 & 0 \\ 0 & 0 & ⋱ & 0 \\ 0 & 0 & 0 & {σ}_{{AOA}_{n}}^{2}\end{matrix} ]}^{- 1} \\ = [ \begin{matrix}\frac{1}{{σ}_{{AOA}_{1}}^{2}} & 0 & 0 & 0 \\ 0 & \frac{1}{{σ}_{{AOA}_{2}}^{2}} & 0 & 0 \\ 0 & 0 & ⋱ & 0 \\ 0 & 0 & 0 & \frac{1}{{σ}_{{AOA}_{n}}^{2}}\end{matrix} ]\end{matrix} \qquad Equation 23$$

As another example, where the azimuth angles θ, the cone angles φ, and the depression angles DA are correlated, the matrix W can be expressed differently. For example, given an observation in which an azimuth angle θ and a cone angle φ are correlated, the matrix W can take the following form:

$$\begin{matrix}w ( θ , φ ) = {[ COV ( θ , φ ) ]}^{- 1} \\ = {[ \begin{matrix}{σ}_{θ}^{2} & {ρσ}_{θ} {σ}_{φ} \\ {ρσ}_{θ} {σ}_{φ} & {σ}_{φ}^{2}\end{matrix} ]}^{- 1} \\ = [ \begin{matrix}\frac{1}{{σ}_{θ}^{2} ( 1 - {ρ}^{2} )} & \frac{- ρ}{{σ}_{θ} {σ}_{φ} ( 1 - {ρ}^{2} )} \\ \frac{- ρ}{{σ}_{θ} {σ}_{φ} ( 1 - {ρ}^{2} )} & \frac{1}{{σ}_{φ}^{2} ( 1 - {ρ}^{2} )}\end{matrix} ]\end{matrix} \qquad Equation 24$$

For a set of multiple observations, the matrix W can take the following form:

$$W = [ \begin{matrix}\frac{1}{{σ}_{{θ}_{1}}^{2} ( 1 - {ρ}^{2} )} & \frac{- ρ}{{σ}_{{θ}_{1}} {σ}_{{φ}_{1}} ( 1 - {ρ}^{2} )} & 0 & 0 & 0 & 0 \\ \frac{- ρ}{{σ}_{{θ}_{1}} {σ}_{{φ}_{1}} ( 1 - {ρ}^{2} )} & \frac{1}{{σ}_{{φ}_{1}}^{2} ( 1 - {ρ}^{2} )} & 0 & 0 & 0 & 0 \\ 0 & 0 & ⋱ & ⋱ & 0 & 0 \\ 0 & 0 & ⋱ & ⋱ & 0 & 0 \\ 0 & 0 & 0 & 0 & \frac{1}{{σ}_{{θ}_{n}}^{2} ( 1 - {ρ}^{2} )} & \frac{- ρ}{{σ}_{{θ}_{n}} {σ}_{{φ}_{n}} ( 1 - {ρ}^{2} )} \\ 0 & 0 & 0 & 0 & \frac{- ρ}{{σ}_{{θ}_{n}} {σ}_{{φ}_{n}} ( 1 - {ρ}^{2} )} & \frac{1}{{σ}_{{φ}_{n}}^{2} ( 1 - {ρ}^{2} )}\end{matrix} ] \qquad Equation 25$$

The e vector can be the difference between the predicted observations at a current estimate for x and the measured observations. Thus, the e vector can take the following form:

$$e = [ \begin{matrix}{\hat{θ}}_{1} ( \hat{x} , \hat{y} , \hat{z} ) - {θ}_{1} \\ {\hat{φ}}_{1} ( \hat{x} , \hat{y} , \hat{z} ) - {φ}_{1} \\ ⋮ \\ ⋮ \\ {\hat{θ}}_{n} ( \hat{x} , \hat{y} , \hat{z} ) - {θ}_{n} \\ {\hat{φ}}_{n} ( \hat{x} , \hat{y} , \hat{z} ) - {φ}_{n}\end{matrix} ] \qquad Equation 26$$

The expression for the e vector in Equation 26 can be ascertained based on the following relationships:

$$θ = {tan}^{- 1} ( \frac{e}{n} ) , and \\ φ = {cos}^{- 1} ( \frac{- u}{\sqrt{{e}^{2} + {n}^{2} + {u}^{2}}} ) . \\ [ \begin{matrix}Δ x \\ Δ y \\ Δ z\end{matrix} ] = [ \begin{matrix}{x}_{collector} - {\hat{x}}_{i} \\ {y}_{collector} - {\hat{y}}_{i} \\ {x}_{collector} - {\hat{z}}_{i}\end{matrix} ] \qquad Equations 27$$

The vector (x_{collector}, y_{collector}, z_{collector}) corresponds to the position of the collector (e.g., the antenna array 12), and thus does not change throughout the iterations of the IWLSA 158. However, the vector (\hat{x}ᵢ, ŷᵢ, \hat{z}ᵢ) corresponds to the estimate for the location of the emitter 54 and changes throughout the iterations of the IWLSA 158.

The pointing vector in the XYZ coordinate system can be transformed into a pointing vector in the ENU coordinate system as follows:

$$[ \begin{matrix}{e}_{i} \\ {n}_{i} \\ {u}_{i}\end{matrix} ] = [ \begin{matrix}{\vec{E}}^{T} \\ {\vec{N}}^{T} \\ {\vec{U}}^{T}\end{matrix} ] [ \begin{matrix}Δ {x}_{i} \\ Δ {y}_{i} \\ Δ {z}_{i}\end{matrix} ] \qquad Equation 28$$

Where:

$$[ \begin{matrix}{\vec{E}}^{T} \\ {\vec{N}}^{T} \\ {\vec{U}}^{T}\end{matrix} ]$$

is equivalent to [\vec{E} \vec{N} \vec{U}]^{T}.
Therefore, the estimate for location (\hat{x}ᵢ, ŷᵢ, \hat{z}ᵢ) allows the IWLSA 158 to compute a pointing vector,

$$[ \begin{matrix}Δ {x}_{i} \\ Δ {y}_{i} \\ Δ {z}_{i}\end{matrix} ] ,$$

and given that the pointing vector in the XYZ coordinate system can be converted into a pointing vector

$$[ \begin{matrix}{e}_{i} \\ {n}_{i} \\ {u}_{i}\end{matrix} ]$$

in the ENU coordinate system, the IWLSA 158 can construct the vector e as follows:

$$\begin{matrix}e = [ \begin{matrix}{\hat{θ}}_{1} ( \hat{x} , \hat{y} , \hat{z} ) - {θ}_{1} \\ {\hat{φ}}_{1} ( \hat{x} , \hat{y} , \hat{z} ) - {φ}_{1} \\ ⋮ \\ ⋮ \\ {\hat{θ}}_{n} ( \hat{x} , \hat{y} , \hat{z} ) - {θ}_{n} \\ {\hat{φ}}_{n} ( \hat{x} , \hat{y} , \hat{z} ) - {φ}_{n}\end{matrix} ] \\ = [ \begin{matrix}{tan}^{- 1} ( \frac{{e}_{1}}{{n}_{1}} ) - {θ}_{1} \\ {cos}^{- 1} ( \frac{- {u}_{1}}{\sqrt{{e}_{1}^{2} + {n}_{1}^{2} + {u}_{1}^{2}}} ) - {φ}_{1} \\ ⋮ \\ ⋮ \\ {tan}^{- 1} ( \frac{{e}_{n}}{{n}_{n}} ) - {θ}_{n} \\ {cos}^{- 1} ( \frac{- {u}_{n}}{\sqrt{{e}_{n}^{2} + {n}_{n}^{2} + {u}_{n}^{2}}} ) - {φ}_{n}\end{matrix} ]\end{matrix} \qquad Equation 29$$

Similar to as described above, the construction of the A matrix or the e vector can be based on the cone angle φ or the depression angle DA. The formulation of Equation 29 demonstrates calculating the geolocation based on the cone angle θ as the observable. However, the formulation can similarly be performed by implementing the depression angle. For example, to implement the depression angle DA in the IWLSA 158, the quantity (π/2−φ) can be substituted in both the matrix A and the vector e appropriately.

Based on the definitions for the matrices A and W and the vector e, the IWLSA 158 can estimate the geolocation of the emitter based on Equation 20, as well as possible additional constraints, as described in greater detail below.

One example of an additional constraint that can be accounted for by the IWLSA 158 is that the depression angle DA may be subject to ray-bending (i.e., atmospheric refraction). Refraction may change the apparent depression angle DA, making it appear more shallow than it really is. To compensate for ray-bending, the IWLSA can model the depression angle DA as follows:

$$e = [ \begin{matrix}{tan}^{- 1} ( \frac{{e}_{1}}{{n}_{1}} ) - {θ}_{1} \\ [ ( \frac{π}{2} - {cos}^{- 1} ( \frac{- {u}_{1}}{\sqrt{{e}_{1}^{2} + {n}_{1}^{2} + {u}_{1}^{2}}} ) ) + {RC}_{1} ] - {DA}_{1} \\ ⋮ \\ ⋮ \\ {tan}^{- 1} ( \frac{{e}_{n}}{{n}_{n}} ) - {θ}_{n} \\ [ ( \frac{π}{2} - {cos}^{- 1} ( \frac{- {u}_{n}}{\sqrt{{e}_{n}^{2} + {n}_{n}^{2} + {u}_{n}^{2}}} ) ) + {RC}_{n} ] - {DA}_{n}\end{matrix} ] \qquad Equation 30$$

Where: RC corresponds to a correction in radians to transform an apparent depression angle DA into a straight-line-to-target depression angle DA.
   The matrix A can also include an RC term, such that the refraction correction is provided in a manner that it is differentiable in the XYZ coordinate system, or can be rotated to the XYZ coordinate system from some other coordinate system, as follows:

$$\begin{matrix}A = {A}_{xyz} \\ = ⌊ \begin{matrix}\frac{\partial {LOB}_{1}}{\partial x} & \frac{\partial {LOB}_{1}}{\partial y} & \frac{\partial {LOB}_{1}}{\partial z} \\ \frac{\partial {DA}_{1}}{\partial x} + \frac{\partial {RC}_{1}}{\partial x} & \frac{\partial {DA}_{1}}{\partial y} + \frac{\partial {RC}_{1}}{\partial y} & \frac{\partial {DA}_{1}}{\partial z} + \frac{\partial {RC}_{1}}{\partial z} \\ ⋮ & ⋮ & ⋮ \\ \frac{\partial {LOB}_{n}}{\partial x} & \frac{\partial {LOB}_{n}}{\partial y} & \frac{\partial {LOB}_{n}}{\partial y} \\ \frac{\partial {DA}_{n}}{\partial x} + \frac{\partial {RC}_{n}}{\partial x} & \frac{\partial {DA}_{n}}{\partial y} + \frac{\partial {RC}_{n}}{\partial y} & \frac{\partial {DA}_{n}}{\partial z} + \frac{\partial {RC}_{n}}{\partial z}\end{matrix} ⌋\end{matrix} \qquad Equation 31$$

Another example of an additional constraint that can be accounted for by the IWLSA 158 is step size of the itertions. As described above, the geolocation calculation component 150 estimates the geolocation of the emitter 54 based on an intersection of the three-dimensional LOP with the Earth's surface (e.g., as determined by the DTED). As also described above, to determine such an intersection, the IWLSA 158 should provide convergence which minimizes a weighted sum of squared error term, e^{T}We from Equation 20. One manner in which the convergence can be ascertained is based on a nearest minimum convergence, such as to determine a geographic region on the DTED where the three-dimensional LOP first intersects the Earth's surface.

By setting the Nadir vector 106 as a starting point, the IWLSA sets step size of the iterations appropriately so as to not overshoot the convergent minimum, as follows:

$$Let [ \begin{matrix}{grad\_step}_{x} \\ {grad\_step}_{y} \\ {grad\_step}_{z}\end{matrix} ] = {( {A}^{T} WA )}^{- 1} {A}^{T} We \qquad Equation 32$$

The magnitude of the gradient step (i.e., iteration step size) can be set as follows:

step_size=\sqrt{grad_stepₓ²+grad_step_{y}²+grad_step_{z}²} Equation 33

If the gradient step is greater than a predetermined size (e.g., 1 km), then the gradient step can be divided by the step_size, as follows:

$$[ \begin{matrix}{grad\_step}_{x}^{′} \\ {grad\_step}_{y}^{′} \\ {grad\_step}_{z}^{′}\end{matrix} ] = [ \begin{matrix}\frac{{grad\_step}_{x}}{step\_size} \cdot bound \\ \frac{{grad\_step}_{y}}{step\_size} \cdot bound \\ \frac{{grad\_step}_{z}}{step\_size} \cdot bound\end{matrix} ] \qquad Equation 34$$

The new grad_step′ will be of size bound (e.g., 1 km) to keep the IWLSA 158 from overshooting the correct minimum. In addition, the IWLSA 158 can be programmed to set a maximum number of iterations for convergence. Furthermore, the IWLSA 158 can set a criterion for stopping the iterations when the value of step_size goes below a certain threshold (e.g., 0.003 m).

In addition, the IWLSA 158 can be programmed to compensate for oscillations that could otherwise cause the IWLSA 158 to not converge, even with infinite iterations, such as resulting from estimates for the altitude of the emitter 54 when the IWLSA 158 takes iteration steps which span multiple DTED altitude cells. One manner that the IWLSA 158 can compensate for oscillations is by recording the last three iteration points along with the current iteration point: \hat{x}ᵢ, \hat{x}ᵢ₋₁, \hat{x}ᵢ₋₂, \hat{x}ᵢ₋₃. The IWLSA 158 can determine the existence of an oscillating state if alt(\hat{x}ᵢ)=alt(\hat{x}ᵢ₋₂) and alt(\hat{x}ᵢ₋₁)=alt(\hat{x}ᵢ₋₃) and alt(\hat{x}ᵢ)≠alt(\hat{x}ᵢ₋₁). The IWLSA 158 can then halt the iterations and perform corrective action or begin again to reach convergence.

Furthermore, the IWLSA 158 can be programmed to treat altitude of the emitter 54 as an observable instead of as a constraint, such as can be the case in typical geolocation systems. Specifically, altitude is considered by the IWLSA 158 as a three-dimensional surface with statistical uncertainty instead of as an absolute constraint. To accomplish this, the IWLSA 158 modifies the matrix A as follows:

$$\begin{matrix}A = {A}_{xyz} \\ = [ \begin{matrix}\frac{\partial {AOA}_{1}}{\partial x} & \frac{\partial {AOA}_{1}}{\partial y} & \frac{\partial {AOA}_{1}}{\partial z} \\ \frac{\partial {AOA}_{2}}{\partial x} & \frac{\partial {AOA}_{2}}{\partial y} & \frac{\partial {AOA}_{2}}{\partial z} \\ ⋮ & ⋮ & ⋮ \\ \frac{\partial {AOA}_{n}}{\partial x} & \frac{\partial {AOA}_{n}}{\partial x} & \frac{\partial {AOA}_{n}}{\partial x} \\ \frac{\partial {Alt}_{n + 1}}{\partial x} & \frac{\partial {Alt}_{n + 1}}{\partial y} & \frac{\partial {Alt}_{n + 1}}{\partial z}\end{matrix} ]\end{matrix} \qquad Equation 35$$

In the matrix A, an (n+1)^{th} row is added at the bottom of the matrix filled with the derivatives of altitude with respect to the XYZ coordinate system. Similarly, in the vector e, an (n+1)^{th} row is added at the bottom of the vector filled with the difference between the altitude of the estimate of the current iteration and the value of altitude from the reference of the Earth's surface (e.g., DTED), as follows:

$$e = [ \begin{matrix}{\hat{θ}}_{1} ( \hat{x} , \hat{y} , \hat{z} ) - {θ}_{1} \\ {\hat{φ}}_{1} ( \hat{x} , \hat{y} , \hat{z} ) - {φ}_{1} \\ ⋮ \\ {\hat{θ}}_{n} ( \hat{x} , \hat{y} , \hat{z} ) - {θ}_{n} \\ {\hat{φ}}_{n} ( \hat{x} , \hat{y} , \hat{z} ) - {φ}_{n} \\ {alt}_{n + 1} ( \hat{x} , \hat{y} , \hat{z} ) - {alt}_{DTED}\end{matrix} ] \qquad Equation 36$$

Where: altₙ₊₁(\hat{x}, ŷ, \hat{z}) is the altitude of the current estimate in three-dimensions above the reference data (e.g., DTED).
   In Equation 36, a conversion between the ECEF and XYZ coordinate systems and the reference data may be necessary to ascertain a value of altₙ₊₁(\hat{x}, ŷ, \hat{z}). The value alt_{DTED} can simply be a lookup value from the digital terrain elevation data source 154. Furthermore, for the matrix W, an (n+1)^{th} row and an (n+1)^{th} column is added, such that in the (n+1)^{th}-by-(n+1)^{th} position of the matrix W, the square of the inverse of the uncertainty of alt_{DTED} is added, as follows:

$$W = [ \begin{matrix}\frac{1}{{σ}_{{θ}_{1}}^{2} ( 1 - {ρ}^{2} )} & \frac{- ρ}{{σ}_{{θ}_{1}} {σ}_{{φ}_{1}} ( 1 - {ρ}^{2} )} & 0 & 0 & 0 & 0 \\ \frac{- ρ}{{σ}_{{θ}_{1}} {σ}_{{φ}_{1}} ( 1 - {ρ}^{2} )} & \frac{1}{{σ}_{{φ}_{1}}^{2} ( 1 - {ρ}^{2} )} & 0 & 0 & 0 & 0 \\ 0 & 0 & ⋱ & 0 & 0 & 0 \\ 0 & 0 & 0 & \frac{1}{{σ}_{{θ}_{n}}^{2} ( 1 - {ρ}^{2} )} & \frac{- ρ}{{σ}_{{θ}_{n}} {σ}_{{φ}_{n}} ( 1 - {ρ}^{2} )} & 0 \\ 0 & 0 & 0 & \frac{- ρ}{{σ}_{{θ}_{n}} {σ}_{{φ}_{n}} ( 1 - {ρ}^{2} )} & \frac{1}{{σ}_{{φ}_{n}}^{2} ( 1 - {ρ}^{2} )} & 0 \\ 0 & 0 & 0 & 0 & 0 & \frac{1}{{σ}_{alt}^{2}}\end{matrix} ] \qquad Equation 37$$

In treating the altitude of the emitter 54 as an observable, it is to be understood that the IWLSA 158 is not concerned with the uncertainty at a single point on the DTED surface. Instead, the altitude uncertainty of concern with respect to the IWLSA 158 is the uncertainty of the region of interest that includes the emitter 54. Both the azimuth angle θ and the depression angle DA have uncertainties that equate to a region in space about the estimate of the geolocation of the emitter 54, and the IWLSA 158 is concerned with the amount that the altitude fluctuates over the uncertainty region of the observables. Thus, the IWLSA 158 can implement a user-defined a priori estimate of regional terrain variance. For example, a sigma-altitude can be set for a predetermined amounts based on terrain, such as 10 meters for flat terrain, 50 meters for hilly terrain, or 200 meters for rugged terrain. Furthermore, the IWLSA 158 can also consider the height-above-terrain (HAT) of the region of interest to account for emitters located on roofs, towers, or other tall structures. HAT can be a predetermined value or range that can be added to the equation for the vector e, as follows:

$$e = [ \begin{matrix}{\hat{θ}}_{1} ( \hat{x} , \hat{y} , \hat{z} ) - {θ}_{1} \\ {\hat{φ}}_{1} ( \hat{x} , \hat{y} , \hat{z} ) - {φ}_{1} \\ ⋮ \\ {\hat{θ}}_{n} ( \hat{x} , \hat{y} , \hat{z} ) - {θ}_{n} \\ {\hat{φ}}_{n} ( \hat{x} , \hat{y} , \hat{z} ) - {φ}_{n} \\ {alt}_{n + 1} ( \hat{x} , \hat{y} , \hat{z} ) - ( {alt}_{DTED} + H . A . T . )\end{matrix} ] \qquad Equation 38$$

Therefore, accounting for altitude observation based on terrain and for structures on which the emitter 54 may be mounted in the models for observations (i.e., in the vector e) and for error (i.e., in the matrix W) can provide marked improvements in accuracy of the final solution provided by the IWLSA 158.

In the example of FIG. 5, the geolocation calculation component 150 also includes an error region calculation component 160. The error region calculation component 160 is configured to generate an error region, demonstrated in the example of FIG. 5 as ER. The error region ER can represent a geographical area associated with a probable location of the emitter. For example, the error region ER can be associated with a percentage of likelihood (e.g., 50%) that the emitter is located in a geographical region encompassed by the error region ER. The error region ER can be generated based on the three-dimensional LOP, such as based on adding uncertainty angles to the three-dimensional LOP.

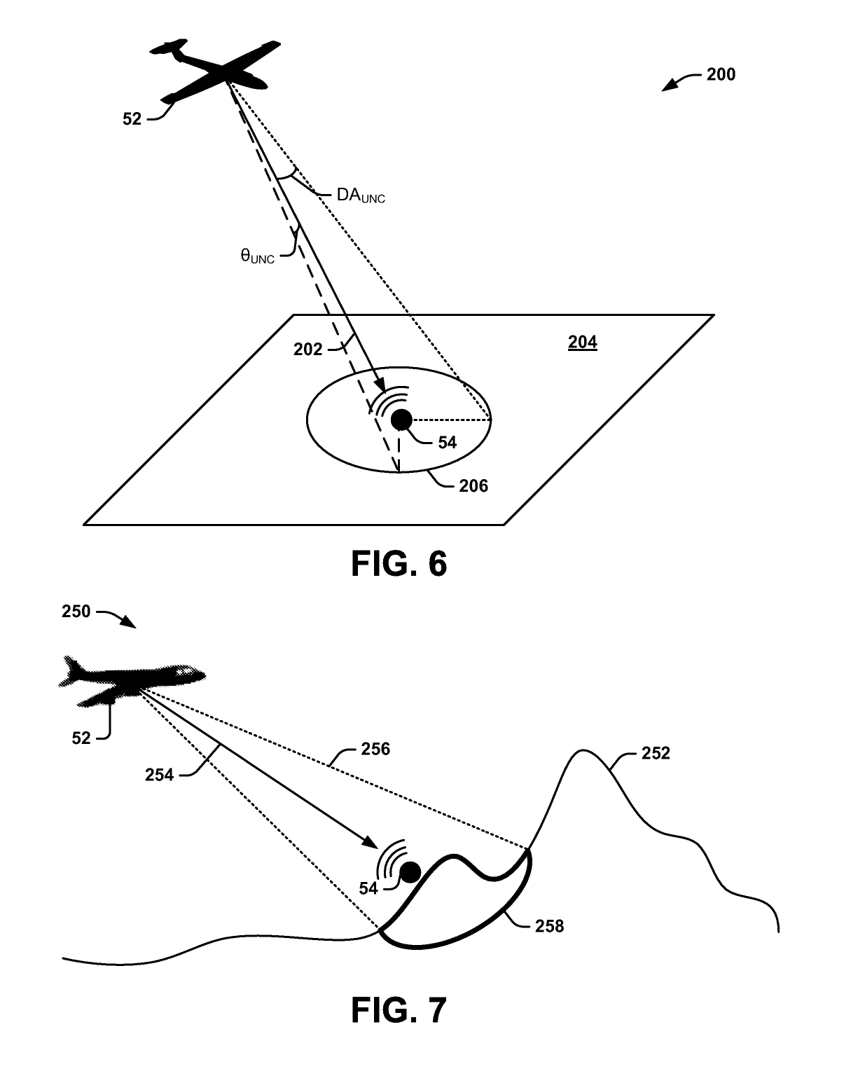

FIG. 6 illustrates an example diagram 200 of generating an error region in accordance with an aspect of the invention. The diagram 200 includes the aircraft 52 and a three-dimensional LOP 202 emanating from the aircraft 52 to the emitter 54 on the Earth's surface 204. As an example, the three-dimensional LOP 202 can be determined by the LOP calculation component 14 based on the phase information PH of one or more signals having been provided from the emitter 54 and received at the antenna array 12. The LOP calculation component 14 can provide an azimuth angle θ (not shown) and depression angle DA (not shown) of the three-dimensional LOP 202 to the fix calculation component 152 for determination of the fix corresponding to the estimate of the location of the emitter 54 on the Earth's surface 204.

In addition, the LOP calculation component 14 can provide the azimuth angle θ (not shown) and depression angle DA (not shown) of the three-dimensional LOP 202 to the error region calculation component 160 for generation of an error region 206. As an example, the error region calculation component 160 can be configured to add a first uncertainty angle θ_{UNC} to the azimuth angle θ and a second uncertainty angle DA_{UNC} to the depression angle DA. As an example, the first uncertainty angle θ_{UNC} can be approximately 1° and the second uncertainty angle DA_{UNC} can be approximately 1.5°. The first and second uncertainty angles θ_{UNC} and DA_{UNC} can each be added positively and negatively to the respective azimuth angle θ and depression angle DA. As a result, the addition of first uncertainty angle θ_{UNC} to the azimuth angle θ and the second uncertainty angle DA_{UNC} to the depression angle DA can generate a cone of uncertainty. Therefore, the error region 206 can be defined based on an intersection of the cone of uncertainty with the Earth's surface 204, such as to generate the error region as an error ellipse.

Referring back to the example of FIG. 5, the error region ER can also be generated based on the DTED provided from the digital terrain elevation data source 154. FIG. 7 illustrates another example diagram 250 of generating an error region in accordance with an aspect of the invention. The diagram 250 demonstrates the aircraft 52 flying over mountainous terrain 252, in accordance with the same Cartesian coordinate system 56 in the examples of FIGS. 2 and 3. Thus, the diagram 250 illustrates a two-dimensional view of the aircraft 52 over the mountainous terrain 252 in the YZ-plane. The diagram 250 also includes the emitter 54 located on the mountainous terrain 252.

The diagram 250 also demonstrates a three-dimensional LOP 254 emanating from the aircraft 52 to the emitter 54 and a cone of uncertainty 256 that substantially surrounds the three-dimensional LOP 254. As an example, the cone of uncertainty 256 can be based on the addition of the first uncertainty angle θ_{UNC} to the azimuth angle θ and the second uncertainty angle DA_{UNC} to the depression angle DA of the three-dimensional LOP 254. Therefore, the error region calculation component 160 can be configured to generate a three-dimensional error region 258 based on an intersection of the cone of uncertainty 256 with the DTED data that represents the mountainous terrain 252. As a result, the three-dimensional error region 258 can provide a better indication of the error region within which the emitter 54 is located.

Referring back to the example of FIG. 5, for an error region ER that is associated with a single-observation measurement, an intersection between the cone of uncertainty and the terrain can represent where the emitter may actually be located given the uncertainty in the measurements obtained by the antenna array 12 and/or the nav unit 156. Because the azimuth angle θ and the depression angle DA are orthogonal to each other, and assuming Gaussian errors on the azimuth angle θ and the depression angle DA, the error region ER is defined as an error ellipse, as demonstrated by the error region 206 in the example of FIG. 6. This error ellipse can thus vary in size based on the distance between the antenna array 12 and the emitter 54.

If the errors in the azimuth angle θ and the depression angle DA are uncorrelated, a covariance matrix can be expressed as follows:

$$COV ( θ , φ ) = {w ( θ , φ )}^{- 1} = [ \begin{matrix}{σ}_{θ}^{2} & 0 \\ 0 & {σ}_{φ}^{2}\end{matrix} ] \qquad Equation 39$$

The equation for the error ellipse that defines the error region ER can be expressed as:

$$\frac{{x}^{2}}{{σ}_{LOB}^{2}} + \frac{{y}^{2}}{{σ}_{DA}^{2}} = 1 \qquad Equation 40$$

The confidence associated with the probability that the emitter 54 resides within the error region ER can be adjusted based on the dimensions of the error region ER. For example, for a 95% confidence error region, the ellipse of Equation 40 can be inflated by 2.447, as follows:

$$\frac{{x}^{2}}{{σ}_{LOB}^{2}} + \frac{{y}^{2}}{{σ}_{DA}^{2}} = \sqrt{- 2 ln ( 0.05 )} = 2.447 \qquad Equation 41$$

As another example, if the errors in the azimuth angle θ and the depression angle DA are instead correlated, a covariance matrix can be expressed as follows:

$$COV ( θ , φ ) = {w ( θ , φ )}^{- 1} = [ \begin{matrix}{σ}_{θ}^{2} & {ρσ}_{θ} {σ}_{φ} \\ {ρσ}_{θ} {σ}_{φ} & {σ}_{φ}^{2}\end{matrix} ] \qquad Equation 42$$

The equation for the error ellipse that defines the error region ER can be expressed as:

$$\frac{{x}^{2}}{{σ}_{LOB}^{2} ( 1 - {ρ}^{2} )} - \frac{2 ρ xy}{{σ}_{LOB} {σ}_{DA} ( 1 - {ρ}^{2} )} + \frac{{y}^{2}}{{σ}_{DA}^{2} ( 1 - {ρ}^{2} )} = 1 \qquad Equation 43$$

Given a single measurement and resulting three-dimensional LOP, σ_{θ} and σ_{φ} can represent the measurement error of the respective angle observations of the azimuth angle θ and the cone angle φ. Assuming that measurement errors are random (i.e., Gaussian), the error region that includes the true azimuth angle θ and cone angle φ to the emitter 54 is represented in two-dimensional angular coordinates by an error ellipse having a center that is located at the observed azimuth angle θ and cone angle φ and having major and minor axes related to the measurement errors σ_{θ} and σ_{φ}.

As an example, if the measurement errors σ_{θ} and σ_{φ} are uncorrelated (i.e., statistically independent), then the size of the 95% confidence error ellipse calculated in Equation 41 is given as follows:

SMA=2.447σ_{φ}

SMI=2.447σ_{θ} Equations 44

Where: SMA corresponds to the semi-major axis of the error ellipse; and
SMI corresponds to the semi-minor axis of the error ellipse.
   As another example, if the measurement errors are correlated, then the size and orientation of the error ellipse can be related to the eigenvalues and eigenvectors of the covariance matrix, as follows:

$${λ}_{max} = \frac{1}{2} [ ( {σ}_{θ}^{2} + {σ}_{φ}^{2} ) + \sqrt{{( {σ}_{φ}^{2} - {σ}_{θ}^{2} )}^{2} + 4 {( {ρσ}_{θ} {σ}_{φ} )}^{2}} ] \\ {λ}_{min} = {σ}_{θ}^{2} + {σ}_{φ}^{2} - {λ}_{max} \\ SMA = 2.447 \sqrt{{λ}_{max}} \\ SMI = 2.447 \sqrt{{λ}_{min}} \\ Ω = \frac{1}{2} {tan}^{- 1} ( \frac{2 {ρσ}_{θ} {σ}_{φ}}{{σ}_{φ}^{2} - {σ}_{θ}^{2}} ) \qquad Equations 45$$

As described above in the example of FIG. 6, in three-dimensions, the error region ER is defined by an elliptical cone of uncertainty with its vertex located at the antenna array 12, with an axis coincident with the angle observations of the azimuth angle θ and the cone angle φ corresponding to the three-dimensional LOP and extending to infinity. With the emitter 54 being located on the surface of the Earth, then the emitter 54 is located in the intersection region of this elliptical cone with the Earth that defines the error region ER. The error region ER can thus be determined by sweeping out rays along the edge of the cone of uncertainty and finding the intersection of these rays with the Earth. A ray coincident with the cone of uncertainty has its origin at the position of the antenna array 12 and a direction given in spherical coordinates θ′, φ′, which for uncorrelated measurement errors can be expressed as follows:

θ′=θ+2.447σ_{θ} sin(ω_{0→2π})

φ′=φ+2.447σ_{φ} cos(ω_{0→2π}) Equation 46

Where: ω is an arbitrary sweep angle that ranges from 0 to 2π.

For correlated measurement errors, the spherical coordinates θ′, φ′ can be expressed as follows:

θ′=θ+SMI sin(ω_{0→2π}−Ω)

φ′=φ+SMA cos(ω_{0→2π}−Ω) Equation 47

All points along a given ray satisfy the parametric equation defined in the ENU coordinate system based on:

$${\vec{x}}_{ENU} = {\vec{v}}_{ENU} + t {\vec{d}}_{ENU} , \\ {\vec{x}}_{ENU} = [ \begin{matrix}0 \\ 0 \\ 0\end{matrix} ] + t [ \begin{matrix}sin ( {θ}^{′} ) sin ( {φ}^{′} ) \\ cos ( {θ}^{′} ) sin ( {φ}^{′} ) \\ cos ( {φ}^{′} )\end{matrix} ] \qquad Equations 48$$

The rays can be defined in the ECEF coordinate system by rotating the direction vectors from the ENU coordinate system to the ECEF coordinate system. Using the rotation matrix as defined in Equations 48, the ray equation can be expressed as:

$${\vec{x}}_{XYZ} = {\vec{v}}_{XYZ} + t {\vec{d}}_{XYZ} \\ {\vec{x}}_{XYZ} = [ \begin{matrix}{x}_{collector} \\ {y}_{collector} \\ {z}_{collector}\end{matrix} ] + t [ \vec{E} \vec{N} \vec{U} ] [ \begin{matrix}sin ( {θ}^{′} ) sin ( {φ}^{′} ) \\ cos ( {θ}^{′} ) sin ( {φ}^{′} ) \\ cos ( {φ}^{′} )\end{matrix} ] \qquad Equations 49$$

The error region is determined by the error region calculation component 160 by intersecting the rays defined by the cone of uncertainty with the Earth's surface. If the Earth is assumed to be an ellipsoid, then the intersection points can be found by constraining points to both lie on the surface of the ellipsoidal Earth and to lie along these rays (i.e., the swept cone). The constraint for points on the ellipsoidal Earth is given as follows:

$${x}^{2} + {y}^{2} + {( α z )}^{2} = {( ER + alt )}^{2} \\ α = {( \frac{ER + alt}{PR + alt} )}^{2} \qquad Equations 50$$

Where:
ER=the Equatorial Radius of the Earth;
PR=the Polar Radius of the Earth; and
alt=altitude above the Earth ellipsoid.
   In vector form, Equations 50 can be expressed as:

[11α]\vec{x}_{XYZ}·[11α]\vec{x}_{XYZ}=(ER+alt)² Equation 51

The constraint for the ray, as provided above, can be expressed as:

\vec{x}_{XYZ}=\vec{v}_{XYZ}+t\vec{d}_{XYZ} Equation 52

Substituting the Equation 52 into Equation 51 yields the quadratic equation of the parameter t of Equation 52, as follows:

\vec{d}′·\vec{d}′t²+2\vec{v}′·\vec{d}′t+\vec{v}′·\vec{v}′−(ER+alt)²=0, where

\vec{d}′=[11α]\vec{d}, and

\vec{v}′=[11α]\vec{v} Equation 53

The roots of t can be determined by the implementing the following quadratic formula:

$$t = \frac{- 2 {\vec{v}}^{′} \cdot {\vec{d}}^{′} \pm \sqrt{\begin{matrix}{( 2 {\vec{v}}^{′} \cdot {\vec{d}}^{′} )}^{2} - \\ 4 ( {\vec{d}}^{′} \cdot {\vec{d}}^{′} ) ( {\vec{v}}^{′} \cdot {\vec{v}}^{′} - {( ER + alt )}^{2} )\end{matrix}}}{{\vec{d}}^{′} \cdot {\vec{d}}^{′}} \qquad Equation 54$$

The intersection points can then be found by substituting t into the Equation 52.

To find the intersection of the cone of uncertainty with the Earth's surface, a ray tracing algorithm can be used. This iterative technique steps along the rays defined above until a point on the ray is found that is below the Earth's elevation. To choose a starting point, the ray is first intersected with an ellipsoid that corresponds to a maximum elevation of the terrain of Earth's surface. If the antenna array 12 is below the maximum elevation, then the ray tracing algorithm can step from the antenna array 12 to the intersection point to search for a point below the terrain. If the antenna array 12 is above the maximum elevation, then the ray tracing algorithm can step from the near intersection point to the far intersection point searching for a point below the terrain. The step size can be adjusted to match the post spacing of the terrain model, such as dictated by DTED.

As another example, the error region calculation component 160 in the example of FIG. 5 can be configured to calculation the error region ER based on a plurality of three-dimensional LOPs based on a respective plurality of observables (i.e., azimuth angles θ and depression angles DA). The error region calculation component 160 can thus generate the error region ER as a three-dimensional error ellipsoid that defines the region in three-dimensional space in which the emitter 54 is likely to reside.

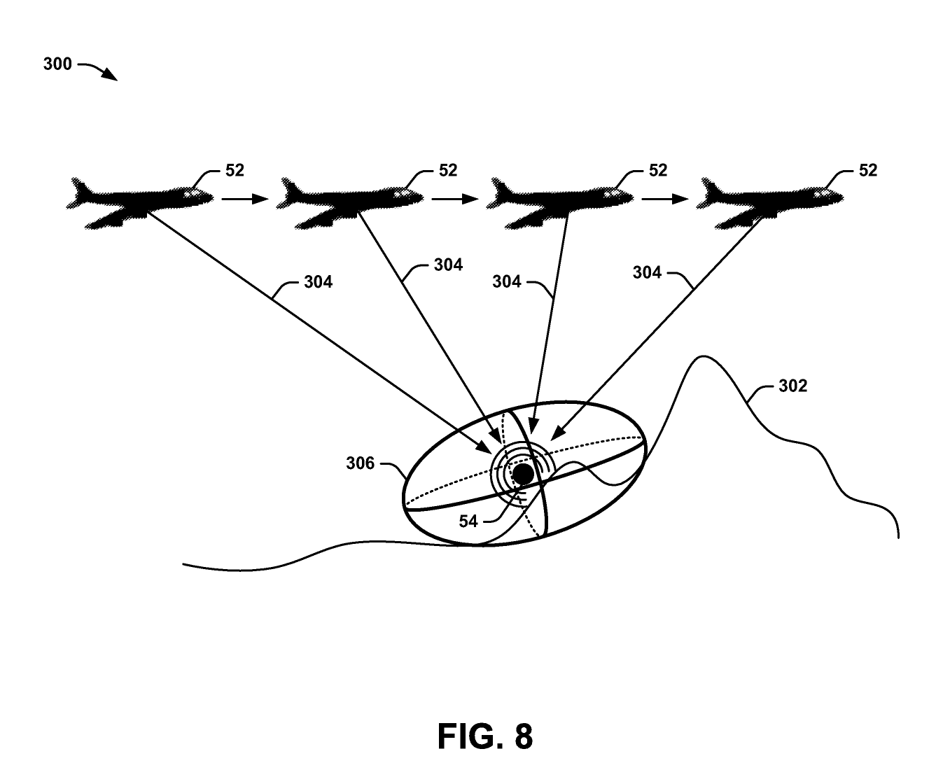

FIG. 8 illustrates yet another example diagram 300 of generating an error region in accordance with an aspect of the invention. The diagram 300 demonstrates the aircraft 52 flying over mountainous terrain 302, in accordance with the same Cartesian coordinate system 56 in the examples of FIGS. 2 and 3. Thus, the diagram 300 illustrates a two-dimensional view of the aircraft 52 over the mountainous terrain 302 in the YZ-plane. The diagram 300 also includes the emitter 54 located on the mountainous terrain 302.

The diagram 300 demonstrates the aircraft 52 at several points in a flight path over the mountainous terrain 302, with a three-dimensional LOP 304 emanating from the aircraft 52 to the emitter 54 at each point of the flight path. Each of the three-dimensional LOPs can be separately determined by the LOP calculation component 14, such that each of the three-dimensional LOPs 304 has a separate respective azimuth angle θ and depression angle DA. Therefore, the error region calculation component 160 can be configured to generate an error region 306 as a three-dimensional error ellipsoid that can be intersected with the DTED data that represents the mountainous terrain 302. As a result, the three-dimensional error region 306 can provide an accurate indication of the error region within which the emitter 54 is located. While the example of FIG. 8 demonstrates the single aircraft 52 generating the plurality of three-dimensional LOPs 304, it is to be understood that the three-dimensional LOPs 304 can each be generated by separate respective aircraft, or a combination of multiple aircraft generating multiple three-dimensional LOPs 304.

The error region calculation component 160 can generate the error ellipsoid as a three-dimensional manifestation of a 3×3 covariance matrix for the estimate \hat{x} of the geolocation of the emitter 54. The covariance of the estimate \hat{x} is given by the expression (A^{T}WA)⁻¹, which can be rotated from the XYZ coordinate system to the ENU coordinate system based on the following operation:

$${( {A}^{T} WA )}_{ENU}^{- 1} = [ \begin{matrix}{\vec{E}}^{T} \\ {\vec{N}}^{T} \\ {\vec{U}}^{T}\end{matrix} ] {( {A}^{T} WA )}_{XYZ}^{- 1} [ \vec{E} \vec{N} \vec{U} ] \qquad Equation 55$$

Thus, the covariance in the ENU coordinate system around the estimate \hat{x} is:

$${COV ( \hat{x} )}_{ENU} = [ \begin{matrix}{σ}_{E}^{2} & … & … \\ {ρ}_{EN} {σ}_{E} {σ}_{N} & {σ}_{N}^{2} & … \\ {ρ}_{EU} {σ}_{E} {σ}_{U} & {ρ}_{NU} {σ}_{N} {σ}_{U} & {σ}_{U}^{2}\end{matrix} ] \\ = {( {A}^{T} WA )}_{ENU}^{- 1} \qquad Equation 56$$

From the covariance matrix of Equation 56, the error region calculation component 160 can derive the features of the three-dimensional error region 306.

As another example, the error region calculation component 160 can implement the 3×3 covariance matrix of Equation 55 for the estimate \hat{x} in a two-dimensional projection of the three-dimensional error region 306. The projection onto the Earth's surface, such as based on the DTED, appears as an ellipse. For example, the error region calculation component 160 can cancel out any component in the covariance matrix of Equation 55 having an upward component, thus leaving projections of the three-dimensional error region 306 in the East-North plane. Specifically, such cancellation of upward components from the three-dimensional matrix is equivalent to removing the East-North upper 2×2 matrix from the full three-dimensional matrix. The result is a 1-sigma covariance matrix for the geolocation estimate \hat{x} in two-dimensions, as described by the following expression:

$${{COV}_{2 \times 2} ( \hat{x} )}_{EN} = [ \begin{matrix}{σ}_{E}^{2} & … & 0 \\ {ρ}_{EN} {σ}_{E} {σ}_{N} & {σ}_{N}^{2} & 0 \\ 0 & 0 & 0\end{matrix} ] \\ = [ \begin{matrix}{σ}_{E}^{2} & {ρ}_{EN} {σ}_{E} {σ}_{N} \\ {ρ}_{EN} {σ}_{E} {σ}_{N} & {σ}_{N}^{2}\end{matrix} ] \qquad Equation 57$$

From the covariance matrix of Equation 57, the error region calculation component 160 can derive the features of the two-dimensional projection of the error region 306.

As yet another example, the three-dimensional error region 306 corresponding to the 3×3 covariance matrix can be intersected with the terrain of the Earth's surface, such as based on the DTED. Given a geolocation estimate that is determined based on the IWLSA 158 as described above, the uncertainty in the geolocation solution can be represented as the volume contained within the three-dimensional error region 306. As demonstrated in the example of FIG. 8, three-dimensional error region 306 is centered at the geolocation estimate of the emitter 54, with the size and orientation of the three-dimensional error region 306 is defined by the covariance matrix (A^{T}WA)⁻¹. A 95% confidence error region ellipsoid can be defined by a set of points that satisfy the following expression:

(p−\hat{x})^{T}(A^{T}WA)^{-l}(p−\hat{x})≦(2.7955)² Equation 58

Where:
(A^{T}WA)⁻¹ is the covariance matrix;
\hat{x} is the geolocation estimate; and
p is a point.

To determine the intersection of the three-dimensional error region 306 and the Earth's terrain, a search technique can be implemented by the error region calculation component 160. To find intersection points, each adjacent pair of terrain posts in the region of the geolocation estimate of the emitter 54 can be considered by the error region calculation component 160. An intersection is determined based on one post lying inside the three-dimensional error region 306 with the adjacent post lying outside the three-dimensional error region 306 (or vice versa). A more accurate intersection point can be calculated by interpolating between the post values to find a point having an ellipsoid-norm that is closer to 2.7955.

To determine line segments that lie on the intersection of the three-dimensional error region 306 with the terrain, the error region calculation component 160 searches for intersection points using posts that form triangles in the Earth's terrain. For each such post, the adjacent post is considered in both latitude and longitude. These three posts form a triangle on the terrain of Earth's surface. If one of the posts lies inside the three-dimensional error region 306, and the other two lie outside the three-dimensional error region 306 (or vice versa), then the triangle intersects the three-dimensional error region 306. The intersection points along the two sides of the triangle that intersect the ellipsoid are then found. These two points define a line segment, and all such line segments found in this manner enclose the three-dimensional error region 306 on the terrain of Earth's surface. This technique can define disconnected regions that lie within the 95% probability error region.

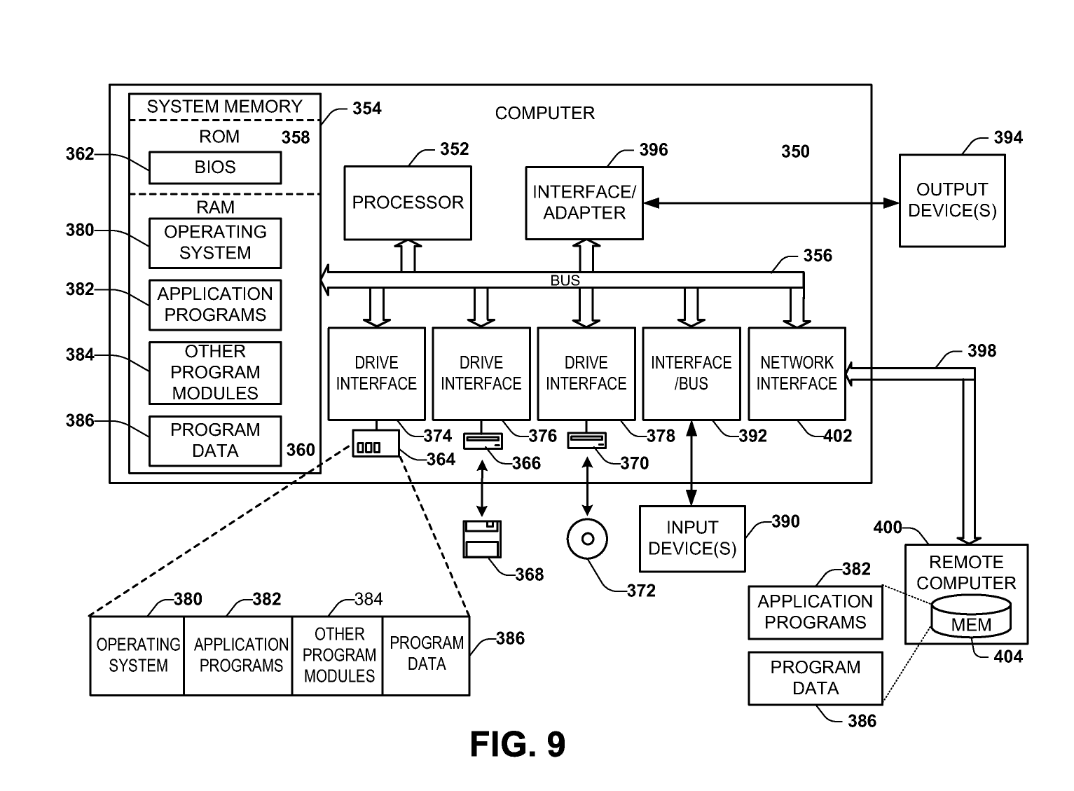

FIG. 9 illustrates a computer system 350 that can be employed to implement systems and methods described herein, such as based on computer executable instructions running on the computer system. The computer system 350 can be implemented on one or more general purpose networked computer systems, embedded computer systems, routers, switches, server devices, client devices, various intermediate devices/nodes and/or stand alone computer systems. Additionally, the computer system 350 can be implemented as part of the computer-aided engineering (CAE) tool running computer executable instructions to perform the methodologies described herein. Specifically, the computer system 350 can be included on the aircraft 52, on the ground, or can be distributed between both the aircraft 52 and ground, and can be configured to generate three-dimensional LOPs, three-dimensional geolocations of the emitter 54, and/or error regions ER for determining the geolocation of the emitter 54.

The computer system 350 includes a processor 352 and a system memory 354. A system bus 356 couples various system components, including the system memory 354 to the processor 352. Dual microprocessors and other multi-processor architectures can also be utilized as the processor 352. The system bus 356 can be implemented as any of several types of bus structures, including a memory bus or memory controller, a peripheral bus, and a local bus using any of a variety of bus architectures. The system memory 354 includes read only memory (ROM) 358 and random access memory (RAM) 360. A basic input/output system (BIOS) 362 can reside in the ROM 358, generally containing the basic routines that help to transfer information between elements within the computer system 350, such as a reset or power-up.

The computer system 350 can include a hard disk drive 364, a magnetic disk drive 366, e.g., to read from or write to a removable disk 368, and an optical disk drive 370, e.g., for reading a CD-ROM or DVD disk 372 or to read from or write to other optical media. The hard disk drive 364, magnetic disk drive 366, and optical disk drive 370 are connected to the system bus 356 by a hard disk drive interface 374, a magnetic disk drive interface 376, and an optical drive interface 384, respectively. The drives and their associated computer-readable media provide nonvolatile storage of data, data structures, and computer-executable instructions for the computer system 350. Although the description of computer-readable media above refers to a hard disk, a removable magnetic disk and a CD, other types of media which are readable by a computer, may also be used. For example, computer executable instructions for implementing systems and methods described herein may also be stored in magnetic cassettes, flash memory cards, digital video disks and the like.

A number of program modules may also be stored in one or more of the drives as well as in the RAM 360, including an operating system 380, one or more application programs 382, other program modules 384, and program data 386.

A user may enter commands and information into the computer system 350 through user input device 390, such as a keyboard, a pointing device (e.g., a mouse). Other input devices may include a microphone, a joystick, a game pad, a scanner, a touch screen, or the like. These and other input devices are often connected to the processor 352 through a corresponding interface or bus 392 that is coupled to the system bus 356. Such input devices can alternatively be connected to the system bus 356 by other interfaces, such as a parallel port, a serial port or a universal serial bus (USB). One or more output device(s) 394, such as a visual display device or printer, can also be connected to the system bus 356 via an interface or adapter 396.

The computer system 350 may operate in a networked environment using logical connections 398 to one or more remote computers 400. The remote computer 398 may be a workstation, a computer system, a router, a peer device or other common network node, and typically includes many or all of the elements described relative to the computer system 350. The logical connections 398 can include a local area network (LAN) and a wide area network (WAN).

When used in a LAN networking environment, the computer system 350 can be connected to a local network through a network interface 402. When used in a WAN networking environment, the computer system 350 can include a modem (not shown), or can be connected to a communications server via a LAN. In a networked environment, application programs 382 and program data 386 depicted relative to the computer system 400, or portions thereof, may be stored in memory 404 of the remote computer 400.

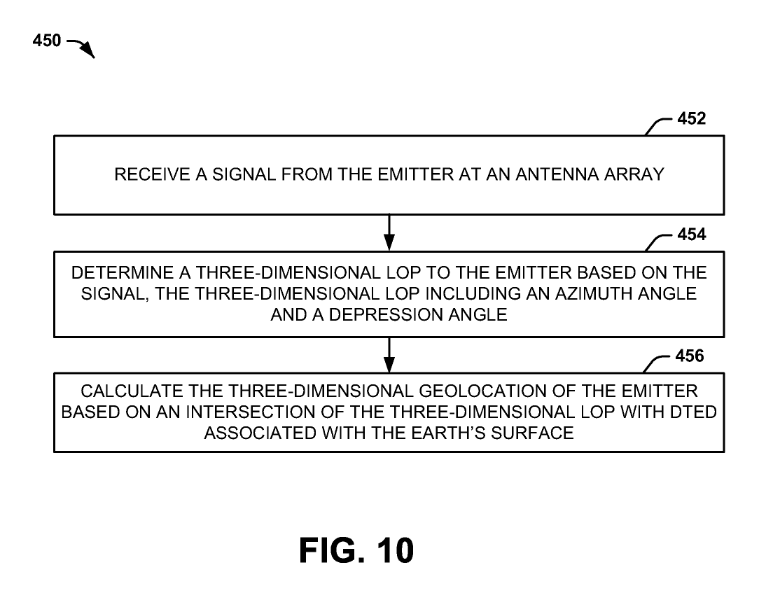

In view of the foregoing structural and functional features described above, a methodology in accordance with various aspects of the present invention will be better appreciated with reference to FIG. 10. While, for purposes of simplicity of explanation, the methodology of FIG. 10 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect of the present invention.

FIG. 10 illustrates an example of a method 450 for determining a three-dimensional geolocation of an emitter. At 452, a signal is received from the emitter at an antenna array. The antenna array can be a three-dimensional antenna array located on an aircraft that receives the signal from a terrestrial emitter. At 454, a three-dimensional LOP to the emitter is determined based on the signal, the three-dimensional LOP including an azimuth angle and a depression angle. The three-dimensional LOP can be determined based on phase information received at the three-dimensional antenna array. At 456, the three-dimensional geolocation of the emitter is calculated based on an intersection of the three-dimensional LOP with DTED associated with the Earth's surface.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A computer readable medium configured to perform a method for determining a three-dimensional geolocation of an emitter, the method comprising:
receiving a signal from the emitter at an antenna array;
determining a three-dimensional line-of-position (LOP) to the emitter based on the signal, the three-dimensional LOP including an azimuth angle and a depression angle; and
calculating the three-dimensional geolocation of the emitter based on an intersection of the three-dimensional LOP with digital terrain elevation data (DTED) associated with the Earth's surface.

2. The method of claim 1, further comprising:
adding a first uncertainty angle to the azimuth angle and a second uncertainty angle to the depression angle;
generating a cone of uncertainty through which the three-dimensional LOP is substantially centered based on the first and second uncertainty angles; and
generating an error region associated with a probable geolocation of the emitter based on an intersection of the cone of uncertainty with the Earth's surface.

3. The method of claim 2, wherein generating the error region comprises generating the error region based on an intersection of the cone of uncertainty with digital terrain elevation data associated with the Earth's surface.

4. The method of claim 1, wherein the signal is one of a plurality of signals, the method further comprising:
receiving the plurality of signals from the emitter at an antenna array along a movement path of an associated aircraft;
determining a plurality of three-dimensional LOPs to the emitter based on each of the respective plurality of signals; and
estimating a most probable three-dimensional geolocation of the emitter based on intersections of the three-dimensional LOP with the DTED associated with the Earth's surface.

5. The method of claim 4, wherein receiving the plurality of signals comprises receiving the plurality of signals from the emitter at an antenna array associated with each of a respective plurality of aircraft.

6. The method of claim 4, further comprising:
generating an error ellipsoid based on the intersections of the three-dimensional LOPs with the DTED associated with the Earth's surface; and
calculating an error region associated with a probable geolocation of the emitter based on an intersection of the error ellipsoid with the Earth's surface.

7. The method of claim 6, wherein calculating the error region comprises calculating the error region based on an intersection of the error ellipsoid with digital terrain elevation data associated with the Earth's surface.

8. The method of claim 1, receiving a signal from the emitter at an antenna array comprises receiving at least one signal from the emitter at an antenna array located on an associated aircraft.

9. The method of claim 1, wherein calculating the three-dimensional geolocation of the emitter comprises implementing an iterative weighted least-squares algorithm based on an intersection of the three-dimensional LOP with the DTED associated with the Earth's surface.

10. A geolocation system comprising:
an airborne antenna array configured to receive at least one signal from an emitter;
a line-of-position (LOP) calculation component configured to calculate a three-dimensional LOP to the emitter that includes an azimuth angle and a depression angle based on phase information associated with the at least one signal; and
a geolocation calculation component configured to calculate the three-dimensional geolocation of the emitter based on an intersection of the three-dimensional LOP with digital terrain elevation data (DTED) associated with the Earth's surface, and to generate an error region associated with a probable geolocation of the emitter on the DTED associated with the Earth's surface based on the three-dimensional LOP.

11. The system of claim 10, wherein the geolocation calculation component comprises an error region calculation component configured to add a first uncertainty angle to the azimuth angle and a second uncertainty angle to the depression angle, to generate a cone of uncertainty through which the three-dimensional LOP is substantially centered based on the first and second uncertainty angles, and to generate the error region based on an intersection of the cone of uncertainty with the DTED associated with the Earth's surface.

12. The system of claim 10, wherein the antenna array is configured to receive a plurality of signals from the emitter, such that the LOP calculation component is configured to calculate a plurality of three-dimensional LOPs to the emitter associated with each of the plurality of signals, wherein the geolocation calculation component is configured to estimate a most probable three-dimensional geolocation of the emitter based on intersections of the three-dimensional LOPs with the DTED associated with the Earth's surface.

13. The system of claim 12, wherein the geolocation calculation component is further configured to generate a three-dimensional error ellipsoid based on the intersections of the three-dimensional LOPs with the DTED associated with the Earth's surface.

14. The system of claim 13, wherein the geolocation component is further configured to calculate an error region associated with a probable geolocation of the emitter based on an intersection of the error ellipsoid with the DTED associated with the Earth's surface.

15. The system of claim 10, wherein calculating the three-dimensional geolocation of the emitter comprises implementing an iterative weighted least-squares algorithm based on an intersection of the three-dimensional LOP with the DTED associated with the Earth's surface.

16. A computer readable medium configured to perform a method for determining a three-dimensional geolocation of an emitter, the method comprising:
receiving at least one signal from the emitter at an antenna array;
determining at least one three-dimensional line-of-position (LOP) to the emitter based on phase information associated with the respective at least one signal, each of the at least one LOP including an azimuth angle and a depression angle; and
generating an error region associated with a probable geolocation of the emitter based on an intersection of the at least one three-dimensional LOP with digital terrain elevation data (DTED) associated with the Earth's surface.

17. The method of claim 16, wherein generating the error region comprises:
adding a first uncertainty angle to the azimuth angle and a second uncertainty angle to the depression angle of the at least one three-dimensional LOP;
generating a cone of uncertainty through which the at least one three-dimensional LOP is substantially centered based on the first and second uncertainty angles; and
generating the error region based on an intersection of the cone of uncertainty with digital terrain elevation data (DTED) associated with the Earth's surface.

18. The method of claim 16, wherein the at least one signal comprises a plurality of signals, the method further comprising:
receiving the plurality of signals from the emitter at the antenna array along a movement path of an associated aircraft; and
determining a plurality of three-dimensional LOPs to the emitter associated with each of the respective plurality of signals, wherein generating the error region comprises generating the error region based on the plurality of three-dimensional LOPs.

19. The method of claim 18, further comprising:
generating an error ellipsoid based on the intersections of the three-dimensional LOPs with the Earth's surface; and
calculating the error region based on an intersection of the error ellipsoid with the Earth's surface.

20. The method of claim 19, wherein generating the error ellipsoid comprises generating the error ellipsoid based on the intersections of the three-dimensional LOPs with digital terrain elevation data (DTED) associated with the Earth's surface, and wherein calculating the error region comprises calculating the error region based on an intersection of the error ellipsoid with the DTED associated with the Earth's surface.
